(19) United States
(12) Patent Application Publication
(10) Pub. No.: US 2014/0349141 A1
(43) Pub. Date: Nov. 27, 2014

(54) BATTERY PACK

(71) Applicant: Samsung SDI Co., Ltd., Yongin-si (KR)

(72) Inventor: Sang-Il Yi, Yongin-si (KR)

(73) Assignee: Samsung SDI Co., Ltd., Yongin-si (KR)

(21) Appl. No.: 14/075,885

(22) Filed: Nov. 8, 2013

(30) Foreign Application Priority Data
May 24, 2013 (KR) 10-2013-0059266

(51) Int. Cl. H01M 2/34

(52) U.S. Cl. CPC H01M 2/348
USPC 429/7

(57) ABSTRACT

A battery pack includes: a battery cell; a first printed circuit board (PCB) including a temperature safety device electrically connected with the battery cell; and a second PCB electrically connected with the first PCB and controlling charging and discharging operation, wherein the first PCB includes a lead tab electrically connected with the temperature safety device, and a base substrate bound with the lead tab by soldering to support the same. The first PCB including the temperature safety device electrically connected with the battery cell and that is arranged on a charging/discharging path of the battery cell may be manufactured through a simplified process.

### RELATED APPLICATIONS

This application claims the benefit of Korean Patent Application No. 10-2013-0059266, filed on May 24, 2013, in the Korean Intellectual Property Office, the disclosure of which is incorporated herein by reference.

### BACKGROUND

1. Field

One or more embodiments of the present invention relate to a battery pack.

2. Description of the Related Technology

With advances in wireless internet or communication technologies, use of portable computers operable with batteries, such as tablet PCs or laptops, has been widespread. Due to advantages of portable PCs, such as compact size, convenience to carry and high mobility, portables PCs have been in wide use for business or personal purposes. For use anywhere without a power supply unit, a portable computer may include a built-in battery pack. The battery pack may include a repeatedly chargeable and dischargeable secondary battery.

A battery pack safe for long-term use may include a structure for sensing an abnormal condition such as overheating of the battery pack and preventing an accident such as an explosion.

### SUMMARY OF CERTAIN INVENTIVE ASPECTS

One or more embodiments of the present invention include a battery pack including a first printed circuit board (PCB) manufactured through a simplified process, the first PCB including a temperature safety device electrically connected with a battery cell and that is arranged on a charging/discharging path of the battery cell.

Additional aspects will be set forth in part in the description which follows and, in part, will be apparent from the description, or may be learned by practice of the presented embodiments.

According to one or more embodiments of the present invention, a battery pack includes: a battery cell; a first printed circuit board (PCB) including a temperature safety device electrically connected with the battery cell; and a second PCB electrically connected with the first PCB and controlling charging and discharging operation, wherein the first PCB includes a lead tab electrically connected with the temperature safety device, and a base substrate bound with the lead tab by soldering to support the same.

The lead tab may include: a first lead tab connected with a first electrode terminal of the battery cell and one electrode of the temperature safety device; and a second lead tab connected with another electrode of the temperature safety device.

The first lead tab may include a first part connected with the first electrode terminal of the battery cell, and a second part connected with the temperature safety device, wherein the first and second parts may have a step difference from each other.

The first part may be exposed to the first electrode terminal via a terminal hole of the base substrate, and the second part may be exposed to the temperature safety device via an assembling hole of the base substrate.

The first PCB may be offset to a side of the battery cell from the middle.

The first PCB may be connected with a first electrode terminal arranged in the middle of the battery cell, and a second electrode terminal may be exposed on a side of the battery cell opposite to the first PCB.

The base substrate may include an assembling hole for the temperature safety device, and the temperature safety device may be connected with the first and second lead tabs exposed through the assembling hole.

The base substrate may include tab support units on opposite sides of the assembling hole, the tab support units supporting the first and second lead tabs.

The first and second lead tabs and the temperature safety device may be bound by welding.

The base substrate may include a terminal hole for connecting the first lead tab on a first surface of the base substrate and the first electrode terminal of the battery cell facing on a second surface of the base substrate.

The base substrate may include a first surface on which the lead tab is disposed, and a second surface opposite to the first surface, and a fixing piece via which the first PCB and the battery cell are bound is disposed on the second surface.

The fixing piece may include a pair of fixing pieces disposed on opposite end portions of the base substrate, respectively.

The fixing piece may be bound to the base substrate by soldering.

A soldering material may be interposed between the lead tab and the base substrate, and between the fixing piece and the base substrate.

The base substrate may be a double-sided PCB.

The base substrate may include: an insulating substrate; a first metal pattern formed in a first surface of the insulating substrate and bound with the lead tab by soldering; and a second metal pattern formed in a second surface of the insulating substrate and bound with the fixing piece by soldering.

The battery cell may include at least two battery cells, and a lead plate for electrically connecting the at least two battery cells may be interposed between the first PCB and the second PCB.

The lead tab may include: a first lead tab connected with a first electrode terminal of a corresponding battery cell and one electrode of the temperature safety device; and a second lead tab electrically connected with the other electrode of the temperature safety device and the lead plate.

The first PCB may include at least two first PCBs electrically connected with the at least two battery cells, respectively, and the second PCB may be shared by the at least two battery cells and may be connected to the lead plate.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic exploded perspective view of a battery pack according to an embodiment of the present invention.

FIG. 2 is a partial schematic exploded perspective view of the battery pack of FIG. 1, according to an embodiment of the present invention;

FIG. 3 is a schematic plan view of a lead plate in FIG. 1, according to an embodiment of the present invention;

FIG. 4 is an exploded perspective view of a first PCB in FIG. 2, according to an embodiment of the present invention;

FIG. 5 is a cross-sectional view of the first PCB of FIG. 4;

FIGS. 6A to 6D are cross-sectional views illustrating a method of manufacturing a first PCB, according to an embodiment of the present invention; and

FIGS. 7A to 7D are schematic perspective views for illustrating a method of manufacturing a first PCB, according to a comparative embodiment.

### DETAILED DESCRIPTION OF CERTAIN INVENTIVE EMBODIMENTS

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

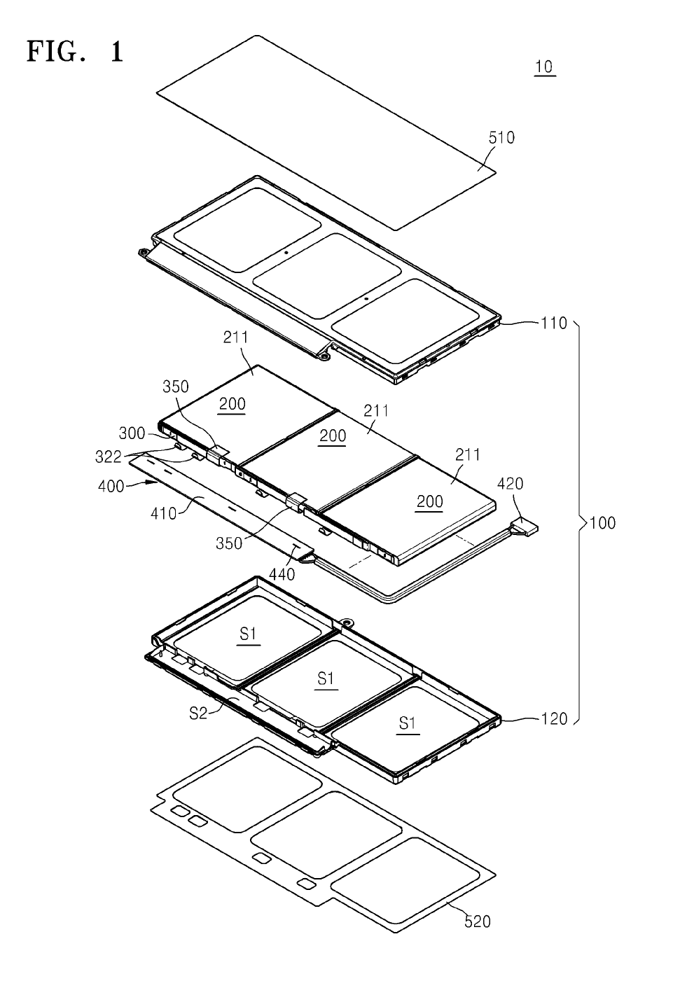

FIG. 1 is a schematic exploded perspective view of a battery pack 10 according to an embodiment of the present invention.

Referring to FIG. 1, the battery pack 10 includes a plurality of battery cells 200, a lead plate 300 electrically connecting the plurality of battery cells 200, a first printed circuit board (PCB, not shown) disposed between the battery cells 200 and the lead plate 300, and a second PCB 400 electrically connected to the lead plate 300. The plurality of battery cells 200, the lead plate 300, and the second PCB 400 are accommodated in a case 100.

The case 100 may include an upper case 100 and a lower case 120 that are coupled to each other. The upper case 110 and the lower case 120 may be coupled to each other by hook structure disposed along a sidewall thereof. At least one of the upper case 110 and the lower case 120 may provide a space S1 for receiving each battery cell 200, and a space S2 for receiving the second PCB 400.

An exterior material for the battery cells 200, which are accommodated in the case 100, may be a can including a metallic material. In this regard, to avoid unnecessary electrical connection of the battery cells 200, the case 100 may include an insulating material. For example, the case 100 may include a plastic injection-molded product.

To reduce the overall thickness of the case 100, an upper surface of the upper case 110 or a lower surface of the lower case 120 may include an opening to expose a corresponding region of the upper or lower surfaces of the battery cells 200. The openings of the upper case 110 and the lower case 120 may be covered by label sheets 510 and 520 attached to the upper case 110 and the lower case 120, respectively.

The plurality of battery cells 200 as rechargeable secondary batteries may include, for example, lithium ion batteries. Each battery cell 200 may include an electrode assembly (not shown) and the exterior material 211 for accommodating the electrode assembly.

The electrode assembly may be manufactured by, for example, forming a stack of a cathode plate and an anode plate with a separator therebetween, and winding them into a jelly-roll form. The exterior material 211 may include aluminum or an aluminum alloy, but is not limited thereto.

The plurality of battery cells 200 may be disposed side by side in a direction. In particular, the battery cells 200 may be disposed such as to allow first electrode terminals (not shown) and second electrode terminals (not shown) of the battery cells 200 to be in the same direction. Although a structure of the battery pack 10 including of three battery packs 200 is illustrated in FIG. 1, embodiments of the present invention are not limited thereto.

The plurality of battery cells 200 may be electrically connected to each other in series, parallel, or series-parallel by the lead plate 300. The lead plate 300 may be bound stable to the battery cells 200 by a tape 350.

The second PCB 400 may serve as a protective circuit module for monitoring and controlling the overall charging and discharging operation of the battery cells 200. For example, the second PCB 400 may receive state information about such as voltages, currents, or temperatures of the battery cells 200 to monitor the current states of the battery cells 200, and may control the charging and discharging operation of the battery cells 200 based on the monitoring results. For example, the second PCB 400 may prevent overheating or exploding caused by overcharging, overdischarging or overcurrent of the battery cells 200.

For example, the second PCB 400 may be connected with the lead plate 300 electrically connecting the plurality of battery cells 200, and thus be shared by the plurality of battery cells 200. A first PCB (not shown) only for each battery cell 200 may be electrically connected to each battery cell 200, which will be described later. The second PCB 400 is distinct from the first PCB only for each battery cell 200. The first PCB and the second PCB 400 are both disposed on a charging/discharging path and provide a protective function against malfunctioning of the battery cells 200. However, a plurality of first PCBs are connected to the battery cells 200, respectively, to protect the individual battery cells 200 from overheating, while the second PCB 400 is disposed between a group of battery cells 200 connected together via the lead plate 300, and an external electronic device (not shown), and measures a charging/discharging current or voltage to provide a protective function against overdischarging, overcharging, or overcurrent for the entire battery cells 200.

The second PCB 400 may include a PCB including a substrate 410 and a plurality of circuit devices (not shown) interconnected via a conductive pattern on the substrate 410. For example, the second PCB 400 may include a protective device (not shown) mount on or in the substrate 410. The protective device may be selected from a safety device including a passive device such as a resistor or a condenser, and an active device such as a transistor, or integrated circuits, or may include all of them

The second PCB 400 may be electrically connected to the lead plate 300. For example, the second PCB 400 and the lead plate 300 may be electrically connected by inserting a plurality of connection protrusions 322 on the lead plate 300 into a plurality of connection grooves 440 in the second PCB 400. The second PCB 400 may include a connector 420 on a terminal thereof for supplying power to an external electronic device.

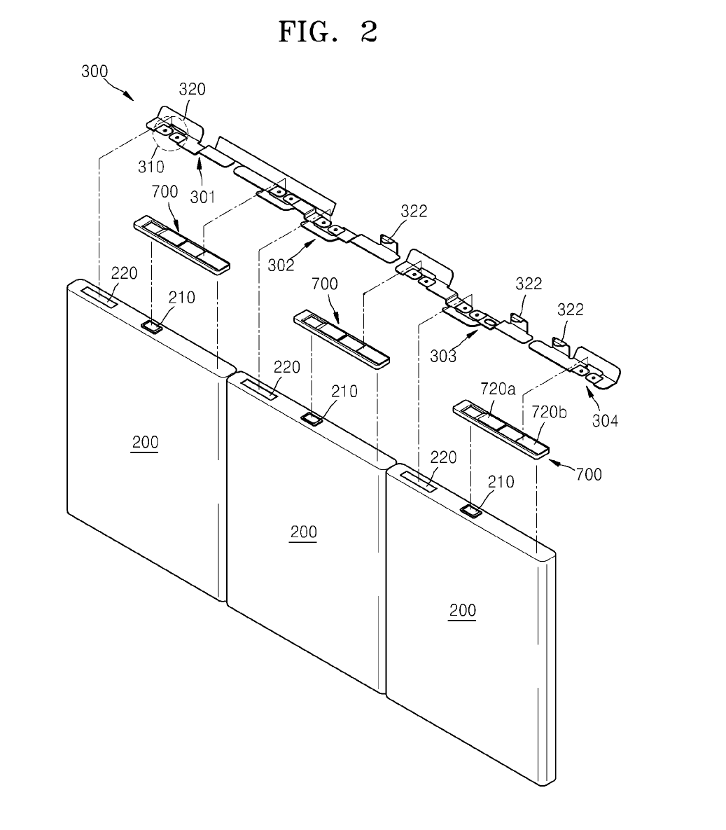

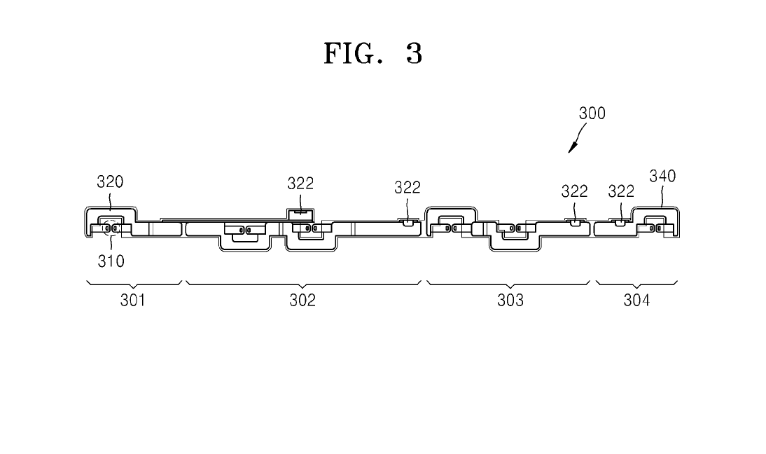

FIG. 2 is a partial schematic exploded perspective view of the battery pack of FIG. 1, according to an embodiment of the present invention. FIG. 3 is a schematic plan view of the lead plate 300 of the battery pack of FIG. 1, according to an embodiment of the present invention.

Referring to FIG. 2, a first electrode terminal 210 and a second electrode terminal 220 as a pair may be disposed on an upper surface of each of the battery cell 200. For example, the first electrode terminal 210 may be in the middle of the upper surface of the battery cell 200, while the second electrode port 220 may be left or right of the upper surface of the battery cell 200. For example, the first electrode terminal 210 may be a negative terminal, and the second electrode terminal 220 may be a positive terminal.

The lead plate 300 may extend along the upper surfaces of the battery cells 200, and may electrically connect the battery cells 200 as a module. Although a structure of three battery cells 200 connected in series is illustrated in FIG. 2, embodiments of the present invention are not limited thereto. In other words, the number or connection scheme, such as series or parallel connection, of the battery cells 200 electrically connected as a module are not limited to the above exemplary embodiments, and may be varied in different forms.

Referring to FIGS. 2 and 3, the lead plate 300 may include a plurality of conductive plates 301, 302, 303, and 304, which have conductivity and each electrically connect adjacent two of the battery cells 200, and an insulating film 340 covering and connecting the plurality of conductive plates 301, 302, 303, and 304.

In particular, the lead plate 300 may include a first conductive plate 301, a second conductive plate 302, a third conductive plate 303, and a fourth conductive plate 304. For example, the second conductive plate 302 and the third conductive plate 303 may each directly electrically connect adjacent two of the battery cells 200. The first conductive plate 301 and the fourth conductive plate 304 may be electrically connected to an external electronic device (not shown). That is, the first conductive plate 301 and the fourth conductive plate 304 may serve as terminals.

The insulating film 340 connects the separate conductive plates 301,302,303, and 304 by covering them, and may prevent a short among the conductive plates 301, 302, 303, and 304, and allow them to be aligned at once, thus simplifying the manufacture of the battery pack 100.

The conductive plates 301, 302 303, and 304 may each include a welding unit 310 exposed by the insulating film 340. The welding unit 310 may be welded to the first electrode terminal 210 or the second electrode terminal 220 of the battery cell 200. For example, the welding unit 310 may be welded to the first electrode terminal 210 or the second electrode terminal 220 of the battery cell 200, thereby being electrically connected to the battery cell 200.

The welding unit 310 may include a pair of welding terminals separated from one another. The plurality of conductive plates 301, 302, 303, and 304 may each include a bypass unit 320 for electrically connecting a pair of welding terminals via a bypass.

Referring back to FIG. 2, a first PCB 700 may be disposed between each of the battery cells 200 and the lead plate 300, as a medium for electrical connection between the battery cell 200 and the lead plate 300. The first PCB 700 may form an electrical path between the battery cell 200 and the lead plate 300, and particularly, between the first electrode terminal 210 of the battery cell 200 and the welding unit 310 of the lead plate 300.

For example, the first PCB 700 may be connected to the first electrode terminal 210 disposed in the middle of the upper surface of the battery cell 200, and be a side on the upper surface of the battery cell 200. The second electrode terminal 220 may be a side on the upper surface of the battery cell 200 opposite to and exposed by the first PCB 700.

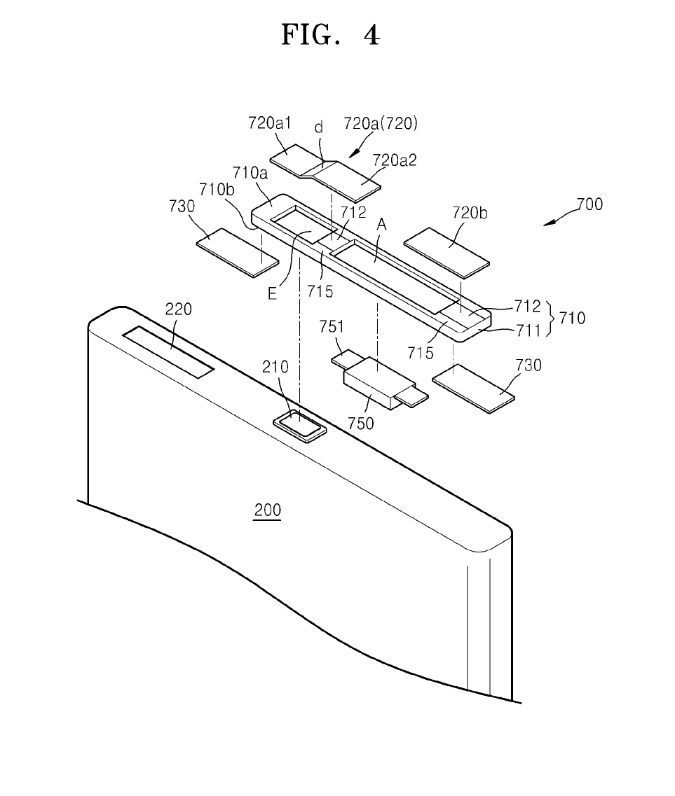

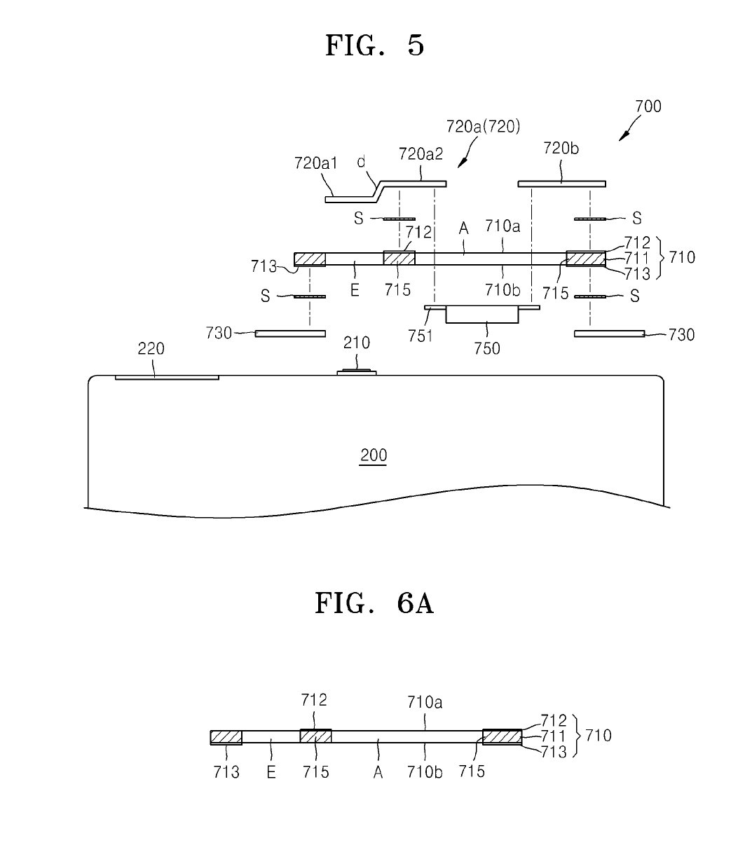

FIG. 4 is an exploded perspective view of the first PCB 700 of FIG. 2, according to an embodiment of the present invention. FIG. 5 is a cross-sectional view of the first PCB 700 of FIG. 4.

Referring to FIGS. 4 and 5, the first PCB 700 includes a base substrate 710, a lead tab 720 disposed on the base substrate 710, and a temperature safety device 750 electrically connected to the lead tab 720.

The base substrate 710 may include a first surface 710a facing the lead plate 300, and a second surface 710b facing the battery cell 200. The lead tab 720, which is electrically connected to the temperature safety device 750, may be disposed on the first surface 710a of the base substrate 710, and a fixing piece 730 for position fixing may be disposed on the second surface 710b of the base substrate 710.

The base substrate 710 may provide an assembling position for the temperature safety device 750 to be on an electrical path between the battery cell 200 and the lead plate 300. In particular, the base substrate 710 may include an assembling hole A for the temperature safety device 750, and a tab support unit 715 for supporting first and second lead tabs 720a and 720b on opposite sides of the assembling hole A in the base substrate 710.

The base substrate 710 may be formed as a double-sided PCB including an insulating substrate 711 and first and second metal patterns 712 and 713 formed in first and second surfaces of the insulating substrate 711. For example, the first metal pattern 712 may be formed in the first surface of the base substrate 710, and the lead tab 720 may be bound onto the first metal pattern 712 by soldering. The second metal pattern 713 may be formed in the second surface of the base substrate 710, and the fixing piece 730 may be bound onto the second metal pattern 713 by soldering.

For example, the first metal pattern 712 may be formed in the tab support unit 715 which the lead tab 720 is fixed to. In another example, two first metal patterns 712 may be formed on opposite sides around the assembling hole A of the base substrate 710, respectively. Two second metal patterns 713 may be formed in opposite end portions of the base substrate 710 which the fixing pieces 730 are fixed to, respectively.

For example, when a double-sided PCB is prepared as the base substrate 710, soldering materials may be placed on the first and second metal patterns 712 and 713 in the first and second surfaces 710a and 710b of the base substrate 710, followed by aligning the lead tab 720 and the fixing piece 730 thereto, and soldering, thereby forming a base substrate assembly with the lead tab 720 and the fixing piece 730 bound thereto. Thereafter, the temperature safety device 750 may be assembled onto the lead tab 720, thereby forming the first PCB 700.

The lead tab 720 may include the first lead tab 720a and the second lead tab 720b disposed on the left and right sides of the assembling hole A of the base substrate 710. For example, the first electrode terminal 210 of the battery cell 200 and an electrode 751 of the temperature safety device 750 may be connected to the first lead tab 720a. The first lead tab 720a may be exposed to the second surface 710b of the base substrate 710 so as to be connected to the first electrode terminal 210 of the battery cell 200.

The first lead tab 720a may include a first part 720a1 positioned in a terminal hole E through which the first electrode terminal 210 of the battery cell 200 is exposed, and a second part 720a2 extending over the assembling hole A for the temperature safety device 750. The first part 720a1 may be exposed to the first electrode terminal 210 through the terminal hole E of the base substrate 710, and the second part 720a2 may be exposed to the temperature safety device 750 through the assembly hole A of the base substrate 710. The first part 720a1 of the first lead tab 720a may be electrically connected to the first electrode terminal 210 of the battery cell 200 by welding. The second part 720a2 of the first lead tab 720a may be electrically connected to the temperature safety device 750 by welding.

The first and second parts 720a1 and 720a2 may have a predetermined step difference (d). In particular, the first part 720a1 may have a predetermined step difference (d) from the second part 720a2 downward toward the first electrode terminal 210 of the battery cell 200 so as to be easily connected to the first electrode terminal 210 through the terminal hole E.

The electrode 751 of the temperature safety device 750 may be electrically connected to the first lead tab 720a, and the other electrode 751 of the temperature safety device 750 may be electrically connected to the second lead tab 720b. The second lead tab 720b connected to the other electrode 751 of the temperature safety device 750 may be electrically connected to the lead plate 300. That is, the second lead tab 720b may electrically connect the temperature safety device 750 and the lead plate 300. The second lead tab 720b and the temperature safety device 750, and the second lead tab 720b and the lead plate 300 may be connected to one another by welding. That is, the first electrode terminal 210 of the battery cell 200 may be electrically connected to the lead plate 300 via the first lead tab 720a, the temperature safety device 750, and the second lead tab 720b.

The temperature safety device 750 may be assembled in a direction from the second surface 710b of the base substrate 710, and may be electrically connected via the assembling hole A with the first and second lead tabs 720a and 720b fixed to the first surface 710a of the base substrate 710. For example, the temperature safety device 750 may be disposed on a current path between the first and second lead tabs 720a and 720b to provide a protective function such as current breaking in an abnormal, overheat condition above a predetermined temperature. For example, the temperature safety device 750 may include a variable resistor having a positive thermal coefficient.

The fixing piece 730 may be disposed on the second surface 710b of the base substrate 710. For example, the fixing piece 730 may be fixed to the upper surface of the battery cell 200 by welding. The position of the first PCB 700 may be fixed by the fixing piece 730. However, embodiments of the present invention are not limited thereto. The fixing piece 730 may be fixed to the upper surface of the battery cell 200 by any of various methods, for example, by a screw, not by welding. For example, a pair of fixing pieces 730 may be disposed on left and right opposite end portions of the based substrate 710, respectively, for more stable position fixing of the first PCB 700.

The fixing piece 730 is not involved in electrical connection between the battery cell 200 and peripheral structures. That is, the battery cell 200 and a peripheral structure, for example, the lead plate 300, may be electrically connected by the first and second lead tabs 720a and 720b. The fixing piece 730 may fix the position of the first PCB 700 to the upper surface of the battery cell 200. The fixing piece 730 and the first and second lead tabs 720a and 720b may be electrically insulated from one another via the base substrate 710.

The fixing piece 730 may be formed of a conductive material such as metal, or an insulating material such as polymer. The fixing piece 730 and the first and second lead tabs 720a and 720b may be formed of the same material, for example, a metallic material such as a nickel plate, for process simplification.

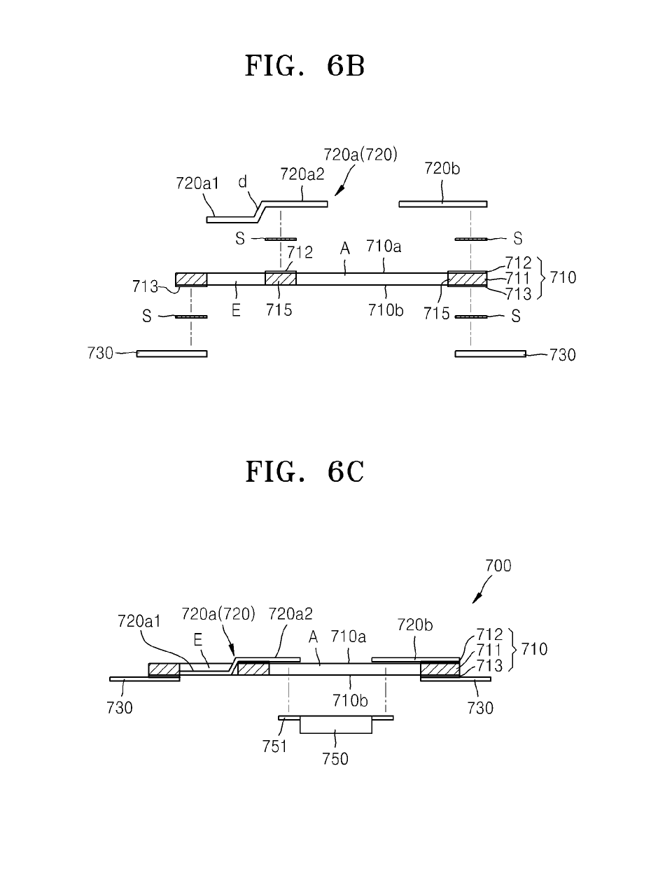

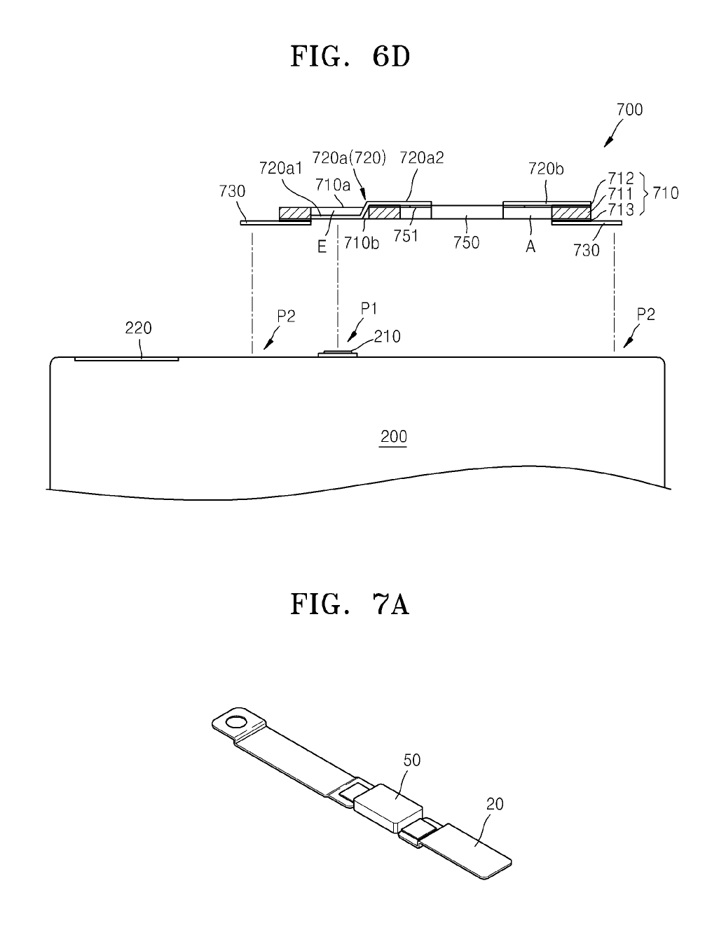

FIGS. 6A to 6D are cross-sectional views illustrating a method of manufacturing a first PCB, according to an embodiment of the present invention.

First, referring to FIG. 6A, a base substrate 710 as a double-sided PCB is prepared. For example, the base substrate 710 may include an insulating substrate 711, and first and second metal patterns 712 and 713 on first and second surfaces of the insulating substrate 711, respectively. For example, the first metal patterns 712 may be formed in tab support units 715 on opposite sides of an assembling hole A. The second metal pattern 713 may be formed on left and right opposite end portions of the insulating substrate 711. The assembling hole A for the temperature safety device 750 may be formed in substantially the middle of the insulating substrate 711. A terminal hole E for exposing the first electrode terminal 210 of the battery cell 200 may be formed adjacent to the assembling hole A.

Next, referring to FIG. 6B, the lead tab 720 and the fixing piece 730 are arranged on the first surface 710a and the second surface 710b of the base substrate 710, respectively, and are bound thereto by soldering. For example, after aligning the lead tab 720 on the first metal pattern 712 a in the first surface 710a of the base substrate 710, and the fixing piece 730 on the second metal pattern 713 in the second surface 710b of the base substrate 710, soldering materials S may be interposed between the first metal pattern 712 and the lead tab 720, and between the second metal pattern 713 and the fixing piece 730, respectively, followed by heating at a high temperature for soldering.

In particular, the lead tab 720 may be aligned on the tab support unit 715 of the base substrate 710, and then bound thereto by soldering while a soldering material S is interposed between the base substrate 710 and the lead tab 720. The fixing piece 730 may be aligned on the second surface 710b of the base substrate 710, and then bound thereto by soldering while a soldering material S is interposed between the base substrate 710 and the fixing piece 730. For example, in the soldering process, the soldering material S may be fused between the base substrate 710 and the lead tab 720, and between the base substrate 710 and the fixing piece 730 by heating at a high temperature.

The lead tab 720 may include a first lead tab 720a exposed to the second surface 710b through the terminal hole E to connect to the first electrode terminal 210 of the battery cell 200, and a second lead tab 720b extending over the assembling hole A to connect to the temperature safety device 750. The fixing piece 730 may include a pair of fixing pieces bound to left and right opposite end portions of the base substrate 170, respectively.

According to one embodiment of the present invention, manufacturing the first PCB 700 may be simplified by using a double-sided PCB as the base substrate 710 and a surface mounting technology such as soldering to bind the lead tab 720/the fixing piece 730 to the base substrate 710. As will be described later, the first PCB 700 for electrically connecting the battery cell 200 and the lead place 300 may also be formed via injection molding and thermal fusing, which though are relatively complicate than soldering.

Next, referring to FIG. 6C, the temperature safety device 750 may be assembled into the assembling hole A of the base substrate 710. For example, the temperature safety device 750 may include a variable resistor having a positive thermal coefficient, and electrodes 751 having different polarities at opposite ends thereof. The temperature safety device 750 may be inserted into the assembling hole A in a direction from the second surface 710b toward the first surface 710a of the base substrate 710, and then positioned such that the electrodes 751 at the opposite end portions thereof overlap with the first and second lead tabs 720a and 720b, respectively, followed by welding to bind them.

Next, referring to FIG. 6D, the first PCB 700 manufactured through the above-described processes are aligned on the battery cell 200 and bound thereto. In particular, after aligning the first PCB 700 on the upper surface of the battery cell 200, the first lead tab 720a is electrically connected to the first electrode terminal 210 of the battery cell 200, and the fixing piece 730 is bound onto the battery cell 200. The first PCB 700 and the battery cell 200 may be bound to one another by welding one spot P1 between the first lead tab 720a and the first electrode terminal 210 for electrical connection and two spots P2 between the fixing pieces 730 at the opposite end portions of the first PCB 700 and the upper surface of the battery cell 200 for position fixing.

The position of the first PCB 700 may be fixed either on a left or right side of the upper surface of the battery cell 200. The first electrode terminal 210 of the battery cell 200 may be electrically connected to the first PCB 700 at a position overlapping with the first PCB 700, and the second electrode terminal 220 of the battery cell 200 may exposed by the first PCB 700 and be electrically connected to the lead plate 300,

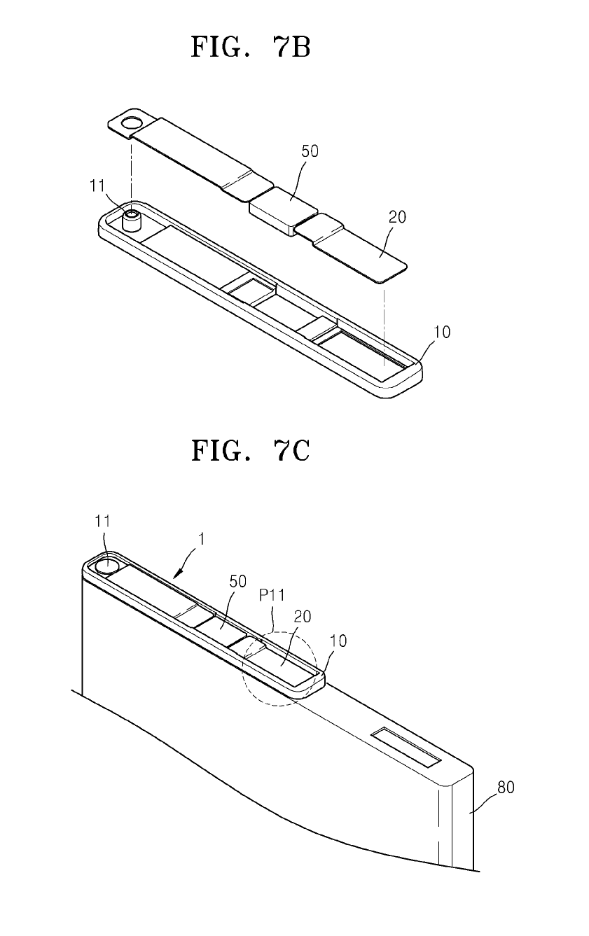

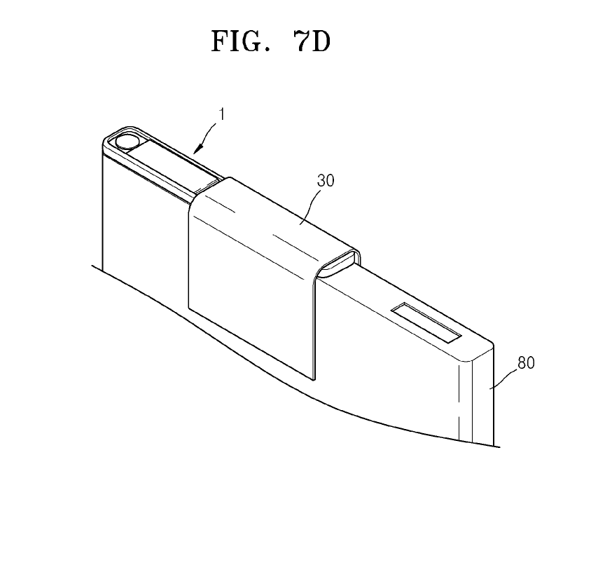

FIGS. 7A to 7D are schematic perspective views for illustrating a method of manufacturing a first PCB, according to a comparative embodiment for comparison with the present invention. Referring to FIG. 7A, connection members 20 are welded to electrodes of a temperature safety device 50 at the opposite end portions thereof. As illustrated in FIG. 7B, after the temperature safety device 50 bound to the connection member 20 is fit into a molded product 10 by pressing, a boss unit 11 of the molded product 10 is thermally fused to bind the temperature safety device 50 and the molded product 10, as illustrated in FIG. 7C, thereby manufacturing a first PCB 1, which is then bound to a battery cell 80, as illustrated in FIG. 7C. That is, the position of the first PCB 1 may be fixed to the battery cell 80 by binding the connection member 20 of the first PCB 1 and a first electrode terminal of the battery cell 80 by welding. Finally, the circumference of the first PCB 1 is covered by a tape member 30 to more stably fix the position of the first PCB 1 on the battery cell 80.

According to the current comparative embodiment, complicate processes such as forming the molded product and thermal fusing are involved in manufacturing the first PCB 1. However, according to embodiments of the present invention, a double-side PCB may be used as the base substrate 710, and the first PCB 700 may be manufactured using a surface mounting technology such as soldering by which the base substrate 710 and the lead tab 720 or the fixing piece 730 may be bound. Accordingly, the manufacturing process of the first PCB 700 is relatively simple than that of the comparative embodiment, and may improve workability and productivity in mass production.

In the comparative example, the first PCB 1 and the battery cell 80 may be bound together by welding only one site (P11) between the connection member 20 and the first electrode terminal of the battery cell 80. This may not ensure sufficient binding strength between the first PCB 1 and the battery cell 80. For this reason, it is necessary to cover the circumference of the first PCB 1 with the tape member 30 to more stably fix the position of the first PCB 1 on the battery cell 80.

In the embodiments of the present invention, a double-side PCB may be used as the base substrate 710. The lead tab 720 for electrical connection and the fixing piece 730 for position fixing may be simultaneously bound at once to the first and second surfaces 710a and 710b of the base substrate 710, respectively, by soldering. That is, the fixing piece 730 may be easily bound to the first PCB 700 without an additional complicate process, in order to stably fix the position of the first PCB 700. Accordingly, unlike the comparative embodiment, an additional tape member 30 or an additional taping process may be not necessary.

As described above, according to the one or more embodiments of the present invention, a first PCB including a temperature safety device electrically connected with a battery cell and that is arranged on a charging/discharging path of the battery cell may be manufactured through a simplified process. No additional member such as a tape for fixing the first PCB onto a battery cell may be used.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A battery pack comprising:
a battery cell;
a first printed circuit board (PCB) including a temperature safety device electrically connected with the battery cell; and
a second PCB electrically connected with the first PCB and controlling charging and discharging operation,
wherein the first PCB comprises a lead tab electrically connected with the temperature safety device, and a base substrate bound with the lead tab by soldering to support the same.

2. The battery pack of claim 1, wherein the lead tab comprises:
a first lead tab connected with a first electrode terminal of the battery cell and one electrode of the temperature safety device; and
a second lead tab connected with another electrode of the temperature safety device.

3. The battery pack of claim 2, wherein the first lead tab comprises a first part connected with the first electrode terminal of the battery cell, and a second part connected with the temperature safety device, wherein the first and second parts have a step difference from each other.

4. The battery pack of claim 3, wherein the first part of the first lead tab is exposed to the first electrode terminal of the battery cell via a terminal hole of the base substrate, and the second part is exposed to the temperature safety device via an assembling hole of the base substrate.

5. The battery pack of claim 1, wherein the first PCB is offset to a side of the battery cell from the middle.

6. The battery pack of claim 5, wherein the first PCB is connected with a first electrode terminal arranged in the middle of the battery cell, and a second electrode terminal is exposed on a side of the battery cell opposite to the first PCB.

7. The battery pack of claim 2, wherein the base substrate comprises an assembling hole for the temperature safety device, and the temperature safety device is connected with the first and second lead tabs exposed through the assembling hole.

8. The battery pack of claim 7, wherein the base substrate comprises tab support units on opposite sides of the assembling hole, the tab support units supporting the first and second lead tabs.

9. The battery pack of claim 7, wherein the first and second lead tabs and the temperature safety device are bound by welding.

10. The battery pack of claim 2, wherein the base substrate comprises a terminal hole for connecting the first lead tab on a first surface of the base substrate and the first electrode terminal of the battery cell facing on a second surface of the base substrate.

11. The battery pack of claim 1, wherein the base substrate comprises a first surface on which the lead tab is disposed, and a second surface opposite to the first surface, and a fixing piece via which the first PCB and the battery cell are bound is disposed on the second surface.

12. The battery pack of claim 11, wherein the fixing piece comprises a pair of fixing pieces disposed on opposite end portions of the base substrate, respectively.

13. The battery pack of claim 11, wherein the fixing piece is bound to the base substrate by soldering.

14. The battery pack of claim 13, wherein a soldering material is interposed between the lead tab and the base substrate, and between the fixing piece and the base substrate.

15. The battery pack of claim 11, wherein the base substrate is a double-sided PCB.

16. The battery pack of claim 15, wherein the base substrate comprises:
an insulating substrate;
a first metal pattern formed in a first surface of the insulating substrate and bound with the lead tab by soldering; and
a second metal pattern formed in a second surface of the insulating substrate and bound with the fixing piece by soldering.

17. The battery pack of claim 1, wherein the battery cell comprises at least two battery cells, and a lead plate for electrically connecting the at least two battery cells is interposed between the first PCB and the second PCB.

18. The battery pack of claim 17, wherein the lead tab comprises:
a first lead tab connected with a first electrode terminal of a corresponding battery cell and one electrode of the temperature safety device; and
a second lead tab electrically connected with the other electrode of the temperature safety device and the lead plate.

19. The battery pack of claim 17, wherein the first PCB comprise at least two first PCBs electrically connected with the at least two battery cells, respectively, and
the second PCB is shared by the at least two battery cells and is connected to the lead plate.
